(19) United States
(12) Patent Application Publication
(10) Pub. No.: US 2025/0158653 A1
(43) Pub. Date: May 15, 2025

(54) METHOD OF SPREADING SPECTRUM OF DATA TRANSMISSION CLOCK AND DEVICE FOR THE METHOD

(71) Applicant: VSI Co. Ltd., Songpa-gu (KR)

(72) Inventors: Suwon Kang, Gyeonggi-do (KR); Jinbae Park, Gyeonggi-do (KR)

(73) Assignee: VSI Co. Ltd., Songpa-gu (KR)

(21) Appl. No.: 18/940,113

(22) Filed: Nov. 7, 2024

(30) Foreign Application Priority Data
Nov. 10, 2023 (KR) 10-2023-0155515

(51) Int. Cl. H04B 1/7085

(52) U.S. Cl. CPC H04B 1/7085

(57) ABSTRACT

A device according to the present disclosure includes: a PLL configured to modulate and output a frequency of a clock used to synchronize communication data in accordance with a regulation signal applied thereto, and a controller configured to generate the regulation signal according to a modulation waveform which is a successive form of a plurality of modulation wave units determined by a set modulation profiled, and apply the regulation signal to the PLL. The modulation wave unit is a signal whose sum of signal values during its time length becomes zero for the first time, and at least two successive modulation wave units among the plurality of modulation wave units differ from each other in at least one of the time length and the form of the signal.

### RELATED PATENT APPLICATION

This application claims priority to Korean Patent Application No. 10-2023-0155515 filed Nov. 10, 2023, the entire contents of which are hereby incorporated by reference for all purposes.

### TECHNICAL FIELD

The present invention relates to spreading frequency spectrum of a clock used to synchronize a data stream when the data stream is transmitted and received between communication devices.

### BACKGROUND

Clock and data recovery (CDR) refers to recovering a clock from a received data stream and using it for data demodulation. However, a square wave of a fixed frequency is generally used as the clock, and its frequency spectrum has a form 1 in which energy is concentrated as illustrated in FIG. 1. As a result, electromagnetic waves that are strongly generated in a specific band cause electromagnetic interference (EMI) problems to signals of other surrounding electronic components, lines or the like.

Because the electromagnetic energy becomes larger as the frequency increases, the necessity to eliminate the negative effects of EMI increases as the communication speed is increasing. The technology proposed to address this necessity is a spread spectrum clock (SSC).

The essence of the spread spectrum clock technology is that the frequency of the clock is changed periodically (T_{SSC}) around the nominal frequency F₀ as illustrated in FIG. 2a, so that the frequency spectrum 2 becomes spread as illustrated in FIG. 2b, which reduces the peak value of the energy (ΔdEₚₖ).

In addition, in order to effectively spread a spectrum of clock, various target modulation patterns other than the target modulation pattern illustrated in FIG. 2a are used, and FIGS. 2c and 2d illustrate these patterns and the spread spectrum of clock resulting therefrom.

However, as can be seen from the pattern of the spread spectrum illustrated, if the modulation pattern is changed, only the intensities of the harmonic components of the nominal frequency fluctuates, and a significant difference does not appear in the peak values (pkE_{ssc1}, pkE_{ssc2}, pkE_{ssc3}) of the spread spectrum. In other words, modulating the frequency in any pattern can slightly shift the particular spectrum that causes the greatest EMI problems, and has no effect on further reducing the intensity of electromagnetic waves in that spectrum.

### DETAILED DESCRIPTION

### Technical Problem

An aspect provides a method of spreading frequency spectrum of a clock that can further reduce the maximum intensity of an electromagnetic wave, and a device for the method.

Another aspect provides a method of spreading frequency spectrum of a clock by frequency-modulating the clock using a non-repetitive modulation waveform, and a device for the method.

Another aspect provides a modulation/demodulation method that enable use of a clock of spread spectrum between transmission/reception devices to which loop-timing is applied, and a device for the method.

Aspects are not limited to the aspect explicitly described above, but of course includes the aspect of achieving an effect that can be derived from the following specific and exemplary descriptions of the present invention.

### Technical Solution

According to an aspect of the present disclosure, there is provided a device that performs data communication with a counterpart device via a transmission channel, the device comprising: a PLL (Phase-Locked Loop) configured to modulate and output a frequency of a clock used to synchronize communication data in accordance with a regulation signal applied thereto, a first controller configured to generate the regulation signal according to a modulation waveform which is a successive form of a plurality of modulation wave units determined by a set modulation profile, and apply the regulation signal to the PLL, a main controller configured to control the first controller so that application of the regulation signal to the PLL is started.

In an embodiment according to the present disclosure, the main controller is configured such that modulation wave units each corresponding to a series of modulation wave unit identifiers set a waveform having a successive form in the order of their identifiers as the modulation profile in the first controller. And, the series of modulation wave unit identifiers are confirmed from data encoded by a component provided in the device, or the information is received from the counterpart device.

The device may have a configuration for a receiver. That is, the clock may be a clock used to capture and receive a signal carried on the transmission channel as a digital signal.

In an embodiment where the device is a receiver, the main controller controls the first controller so that application of the regulation signal to the PLL is started at a time point that a predetermined time elapses from the time point when a specific pattern is detected on the transmission channel. Alternatively, the main controller may control the first controller so that application of the regulation signal to the PLL is started at a time point that a predetermined time elapses from the time point when a message of a specific information is received from the counterpart device. In this case, the specific information may be information notifying that information about the plurality of modulation wave units has been successfully received. Further, the device may be configured such that the clock can also be used to transmit a data stream to the transmission channel, the data stream being for transmitting to the counterpart device. In this case, the device may further comprise: a second PLL configured to modulate and output the frequency of a second clock used to synchronize a data stream transmitted to the counterpart device in accordance with a regulation signal applied thereto, and a MUX (multiplexer) that selects one of the clock and the second clock according to a designated mode and outputs it to be used to synchronize a data stream transmitted to the transmission channel. And, the mode may be designated by a component that is circuit-configured in the device and capable of selectively setting a specific value.

The device may have a configuration for a transmitter. That is, the clock may be a clock used to transmit a data stream to the transmission channel, the data stream being for transmitting to the counterpart device.

In an embodiment according to the present disclosure, the device may further comprise: a second PLL configured to modulate and output a frequency of a second clock recovered from the digital signal, which is used to capture and receive a digital signal from a signal carried on the transmission channel, in accordance with to a second regulation signal applied thereto, and a second controller configured to generate the second regulation signal according to the modulation waveform and apply it to the second PLL. In this case, the main controller controls the second controller so that application of the second regulation signal to the second PLL is started, when the loop time has elapsed from the time point when the first controller is controlled to start application of the regulation signal to the PLL, and the main controller determines the loop time based on a time gap from immediately after transmitting a message to the counterpart device to the time point when the message starts to receive from the counterpart device. More specifically, the main controller may determine, as the loop time, a time obtained by subtracting the previously confirmed reception/transmission switching time of the counterpart device from the time gap.

In an embodiment according to the present disclosure, the device further comprise: a second PLL configured to modulate and output a frequency of a second clock recovered from the digital signal, which is used to capture and receive a digital signal from a signal carried on the transmission channel, in accordance with a second regulation signal applied thereto, a delay unit configured to delay the regulation signal by a delay time according to a delay control signal applied thereto and output it as the second regulation signal, and a tracker configured to regulate a delay time of the regulation signal in the delay unit according to a signal-to-noise ratio of a data stream recovered from the digital signal, and apply the delay control signal corresponding to the regulated delay time to the delay unit. In this embodiment, the tracker is configured to confirm the signal-to-noise ratio of the recovered data stream for each designated interval, and when the presently confirmed second signal-to-noise ratio is lower than the previously confirmed first signal-to-noise ratio, re-apply the delay control signal that was applied to the delay unit when the first signal-to-noise ratio was obtained, and complete regulation of the delay time of the delay unit. Further, the tracker may apply a time gap from just after transmitting a message to the counterpart device to the time point when the message starts to receive from the counterpart device as an initial delay time to the delay unit, and then regulate the delay time to a delay time shorter than the previous delay time each time the delay time is regulated. Alternatively, the tracker may apply a predetermined time as an initial delay time to the delay unit, and then regulate the delay time to a longer delay time than the previous delay time each time the delay time is regulated.

In an embodiment where the device is a transmitter, the main controller may apply the control signal to the first controller, which causes application of the regulation signal to the PLL to start at a time point that a predetermined time elapses from the time point when a signal of a specific pattern is transmitted through the transmission channel.

According to another aspect of the present disclosure, there is provided a method for communicating data with a counterpart device via a transmission channel, the method comprising: a step 1 of confirming the set modulated wave data, s step 2 of setting a modulation waveform as the modulation profile, the modulation waveform being a form in which a plurality of modulation wave units indicated by the confirmed modulation wave data are successively formed, and a step 3 of generating a regulation signal according to the modulation waveform and apply the regulation signal to a PLL configured to modulate and output the frequency of a clock used to synchronize communication data. And, the PLL is configured to modulate the frequency of the clock according to the regulation signal.

In the above-mentioned devices and methods, and embodiments, the modulation wave unit is a signal whose sum of signal values over the time length becomes zero for the first time, and at least two successive modulation wave units among the plurality of modulation wave units may differ from each other in at least one of the time length and the form of the signal.

According to yet another aspect of the present disclosure, a device that performs data communication with a counterpart device via a transmission channel, comprises, in addition to the PLL and the first controller, a second PLL configured to modulate and output a frequency of a second clock recovered from the digital signal, which is used to capture and receive a digital signal from a signal carried on the transmission channel, in accordance with a second regulation signal applied thereto, a delay unit configured to delay the first regulation signal by a delay time according to a delay control signal applied thereto and output it as the second regulation signal, a tracker configured to regulate a delay time of the first regulation signal in the delay unit according to a signal-to-noise ratio of a data stream recovered from the digital signal, and apply the delay control signal corresponding to the regulate delay time to the delay unit, and a main controller configured to control the first controller so that application of the first regulation signal to the first PLL is started, and configured to include wherein the modulation wave unit is a signal whose sum of signal values during its time length becomes zero for the first time, and configured to include a main controller configured to control the tracker to start regulation of the delay time for the first regulation signal.

### Advantageous Effects

A method for spreading spectrum of a data transmission clock according to the present invention as described above, or at least one embodiment of the present invention as described in detail below in conjunction with the accompanying drawings further spreads frequency spectrum of a clock essential for data communication, thereby lowering the maximum intensity of an electromagnetic wave generated by the clock, and this method is applicable to both one-way and two-way communication between two communication devices.

In addition, one embodiment of the present invention can be applied even to both communication devices that use a single clock for data communication between each other by applying loop timing, whereby the maximum intensity of electromagnetic waves by the clock can be lowered even for communication devices to which loop timing is applied, which can reduce the impact of electromagnetic waves on peripheral devices.

Furthermore, even when a communication device in which processing characteristics cannot grasp in the state transition between reception and transmission is adopted one-way to configure a communication system, a solution capable of applying the method for spreading a spectrum of clock according to the present invention is presented by an embodiment of the present invention, which may be more advantageous to embody the present invention as a product.

### BRIEF DESCRIPTION OF THE DRAWINGS

FIG. 1 illustrates the frequency spectrum of a commonly used square wave clock.

FIGS. 2a and 2b illustrate an example of a modulation waveform used for frequency modulation of a clock, and the frequency spectrum of a clock that is spectrum-spread according to frequency modulation by the waveform, together with the non-spread spectrum.

FIGS. 2c and 2d are diagrams illustrating different types of modulation waveforms used for frequency modulation of a clock and the spread spectrum of the clock resulting therefrom, respectively.

FIG. 3a illustrates a set of modulation wave units applicable to a modulation profile used for frequency modulation of a clock according to an embodiment of the present invention.

FIGS. 3b and 3c illustrate different types of modulation wave units applicable to a modulation profile according to another embodiment of the present invention, respectively.

FIGS. 4a and 4b are diagrams illustrating a configuration that determines and applies a modulation profile from a predetermined modulation wave set and a determination method thereof.

FIGS. 5a and 5b are block diagrams illustrating a configuration of a data transmitter and receiver according to an embodiment of the present invention, respectively.

FIG. 6 illustrates a timing when the modulation profile used to spread a spectrum of the clock is applied to the transmission and reception of data according to an embodiment of the present invention.

FIG. 7 illustrates the application timing of a modulation profile in transmission and reception and the process of sharing the corresponding modulation profile according to an embodiment of the present invention.

FIG. 8 is an example of a configuration of a transceiver that transmits and receives data together with frequency modulation of a clock according to an embodiment of the present invention.

FIG. 9 is a diagram illustrating the sharing of modulation profiles used for frequency modulation of a transmission clock and a reception clock that are performed in the transceiver of FIG. 8, and the timing of frequency modulation using the same.

FIG. 10 is an example of a configuration of a transceiver in which a clock recovered from a reception data stream is used for synchronization of data transmission according to an embodiment of the present invention.

FIG. 11 is a diagram showing the timing at which a transceiver providing a clock starts frequency modulation for a reception clock in two transceivers to which loop timing is applied according to an embodiment of the present invention.

FIG. 12 is a block diagram of a transceiver configured so that two transceivers to which loop timing is applied can selectively function as a main transceiver or a sub-transceiver while having the same circuit configuration according to another embodiment of the present invention.

FIG. 13 is a block diagram of a transceiver that can searches and apply frequency modulation timing for a reception clock without understanding the characteristic values of a counterpart transceiver that operates in a loop timing manner according to another embodiment of the present invention.

FIG. 14 is a timing diagram illustrating a state in which the transceiver of FIG. 13 searches and applies frequency modulation timing that matches a reception clock returned by loop timing.

### DETAILED DESCRIPTION

Hereinafter, various embodiments will be described in detail with reference to the accompanying drawings.

In the following description of embodiments according to the present invention and the accompanying drawings, the same numbers denotes the same components unless specified otherwise. Of course, for convenience of explanation and easy of understanding, the same components may also be denoted by different numbers, if necessary.

In the present invention, in order to further spread a frequency spectrum of a clock, the target modulation pattern for the frequency of the clock is made to have a non-repetitive characteristic. In addition, in order to have this target modulation pattern, the signal that controls frequency of the clock is also made to have a non-repetitive characteristic, and the term ‘modulation profile’ is used herein for this signal.

The modulation profile is composed of modulation wave units having different characteristics. Here, the modulation wave unit refers to a signal of an arbitrary waveform satisfying the requirement that the sum of respective signal values (values of the signal processed by the corresponding waveform at any point in time) over the time length of the waveform (the term ‘sum’ may refer to the integral value in the case of a continuous signal, and is also used in a similar sense in the description and claims described hereinafter) becomes zero for the first time, and the characteristic may be the time length of the modulation wave unit or the form of the modulation signal.

The sum of the signal values over that time period becoming zero for the first time means that the frequency of clock, which is changed by the application of the modulation wave, returns to the value just before application of the modulation wave at the time point when the application of the modulation wave is completed. In other words, the total phase change amount of the clock becomes 0, and the phase is returned and fixed to the phase just before application of the modulation wave.

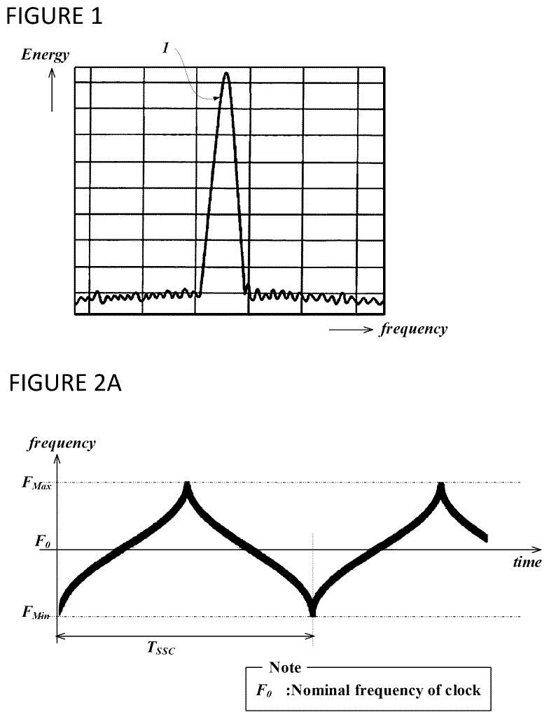

FIG. 1 illustrates the frequency spectrum of a commonly used square wave clock.

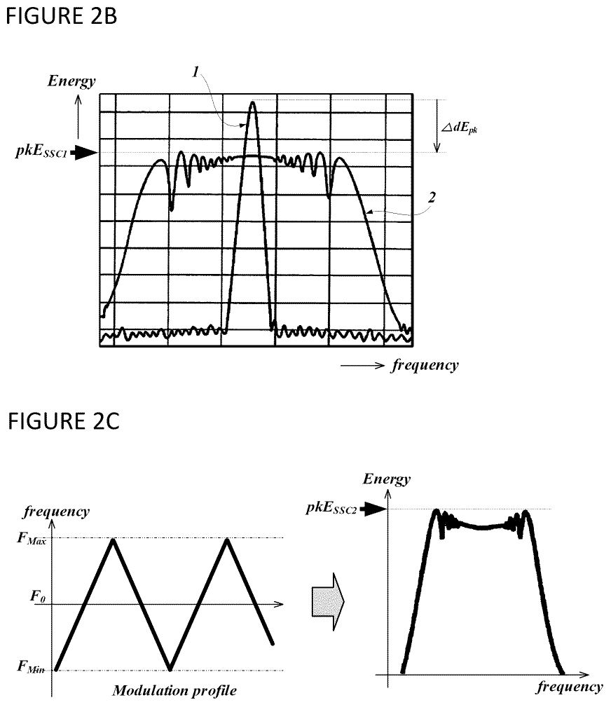

FIGS. 2a and 2b illustrate an example of a modulation waveform used for frequency modulation of a clock, and the frequency spectrum of a clock that is spectrum-spread according to frequency modulation by the waveform, together with the non-spread spectrum.

FIGS. 2c and 2d are diagrams illustrating different types of modulation waveforms used for frequency modulation of a clock and the spread spectrum of the clock resulting therefrom, respectively.

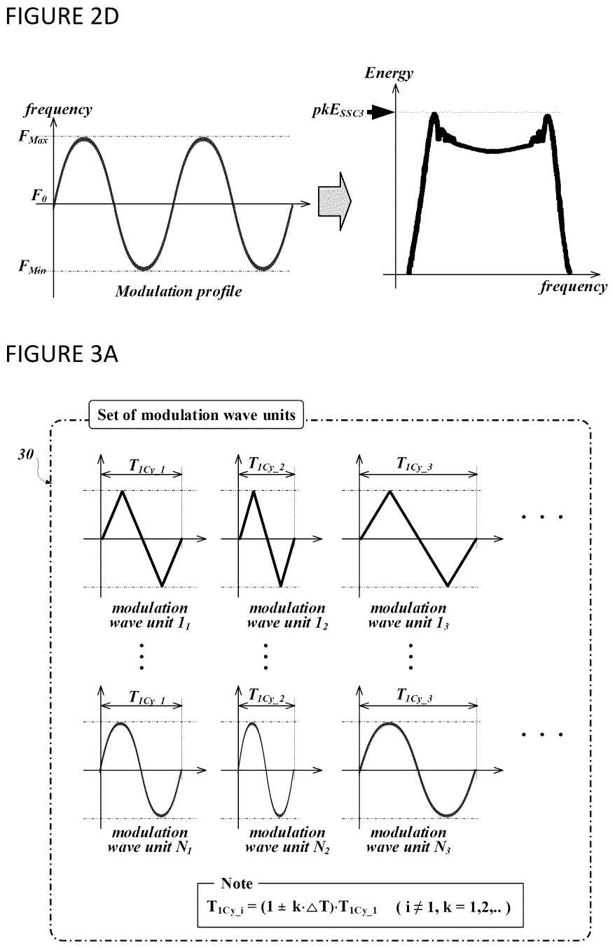

FIG. 3a illustrates a set 10 of modulation wave units applicable to a modulation profile according to an embodiment of the present invention. For each type of modulation wave units (k₁, k=1, . . . , N), the same type of modulation wave units (kⱼ j=2, 3, . . . ) having a plurality of time lengths (T_{1Cy_i}, i=1, 2, 3, . . . ) are provided to constitute a modulation wave set 30. And, each modulation wave unit in the set is given a unique identifier.

The modulation wave units illustrated in FIG. 3a all illustrate successive signal forms, but the technical idea and principle of the present invention are not realized only when successiveness of signals is guaranteed. Even if the modulation wave units have non-successive points, in the case of the waveform that the sum of each signal value becomes 0 for the first time at a specific time length, the waveform up to the specific time length may correspond to the modulation wave unit referred to in this specification and claims. FIG. 3b presents a simple example of this type of modulation wave units.

Furthermore, in an embodiment according to the present invention, the modulation wave unit may be formed as a set of a series of discrete signals. FIG. 3c illustrates the form of such modulation wave units. The modulation wave units illustrated in FIG. 3c are the form of a succession of discrete signals of signal values identical in size and different in sign, and a graph (f_{mod}) of the frequency of the clock modulated by the clock frequency modulation device according to the sequential application of the signal values is illustrated together. This graph shows that the applied discrete signals cumulatively act on frequency modulation.

In this way, even in the case of a modulation wave consisting of a succession of discrete signal values identical in size and different in sign, it is possible to determine the length (T_{1cy_x}) where the sum of the signal values accumulated from the starting point becomes 0 for the first time as illustrated, and when the length is completed, the corresponding frequency modulation amount (total phase change amount) becomes 0 again, so that a series of signal values up to the length (T_{1cy_x}) can be called a modulation wave unit.

The modulation wave set 30 illustrated in FIG. 3a includes all modulation wave units having different time lengths and signal forms, but the modulation wave set may also be configured as modulation wave units different only in time length, or different only in signal form, and the technical concept and sprit of the present invention may also be realized by such an embodiment. Also, although not illustrated in the modulation wave set 30, modulation wave units of the form described as an example in FIG. 3b or 3c may naturally be included in the set. Alternatively, the modulation wave set 30 may be configured as modulation wave units of the form described as an example in FIG. 3b or 3c.

Therefore, the modulation wave set 30 referred to in the following description is based on the premise that a plurality of arbitrary modulation waves are selected from the modulation wave units having the form described as examples in FIGS. 3a to 3c.

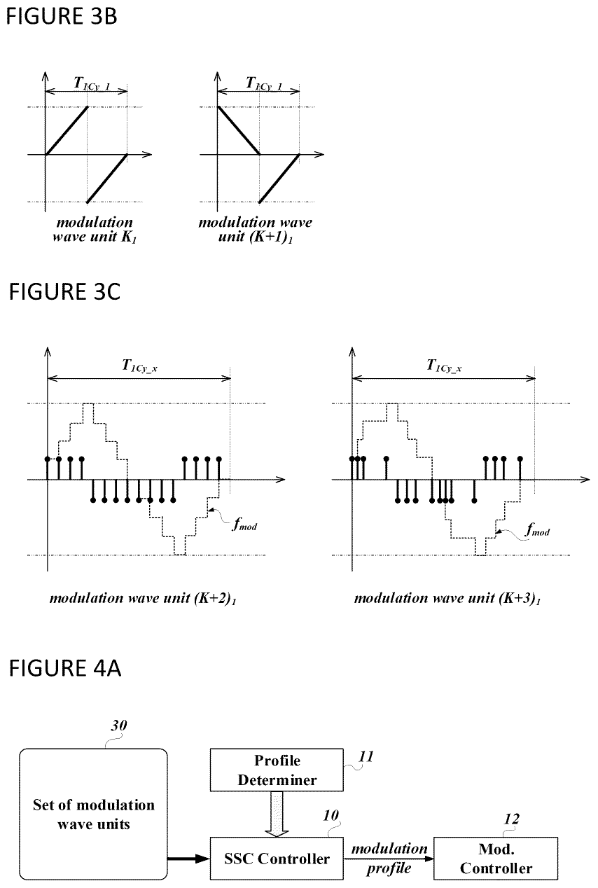

FIGS. 4a and 4b are diagrams illustrating a configuration that determines and applies a modulation profile from a modulation wave set 30 and a determination method thereof. The configuration for determining and applying a modulation profile is realized on the side that provides a transmission clock in data communication between two stages, and includes a profile determiner 11, an SSC controller 10, and a modulation controller 12.

The profile determiner 11 may be data recorded in a circuit, and may be data that is artificially set and encoded outside the device for components such as DIP switches. This data corresponds to identifiers of a series of modulation wave units in the modulation wave set 30. The term ‘modulation sequence’ herein is used for data 11a corresponding to identifiers of a series of modulation wave units.

When the device including the configuration illustrated in FIG. 4a is started up, the SSC controller 10 reads the modulation wave units of the corresponding identifier in the order specified in the modulation wave data with reference to the modulation wave data of the profile determiner 11, and sets them in the modulation controller 12. FIG. 4b assumes that the series of identifiers of the modulation wave units indicated by the modulation wave data of the profile determiner 11 are “1₁, N₃, 2₁, N₂, 1₃, . . . ” (11a), and by the operation of the SSC controller 10 described above, the signal 40 in which the modulation wave units corresponding to each identifier are sequentially created in succession is set as a modulation profile in the modulation controller 12.

As shown as an example in FIG. 4b, unlike a conventional method for spreading a frequency spectrum in which the modulation wave units are repeated, the modulation profile applied to the modulation controller 12 according to the present embodiment repeats the modulation cycle in units of group of modulation wave units specified by the modulation sequence of the profile determiner 11. And, since the modulation signal fluctuates irregularly within this modulation cycle, it is possible to greatly increase the spread of the clock on the frequency spectrum compared to when applying a conventional spread spectrum clock in which modulation wave units are repeated.

Hereinafter, data transmission and reception to which the configuration for spreading the spectrum of a clock using a non-repetitive modulation profile illustrated in FIGS. 4a and 4b is applied will be specifically described.

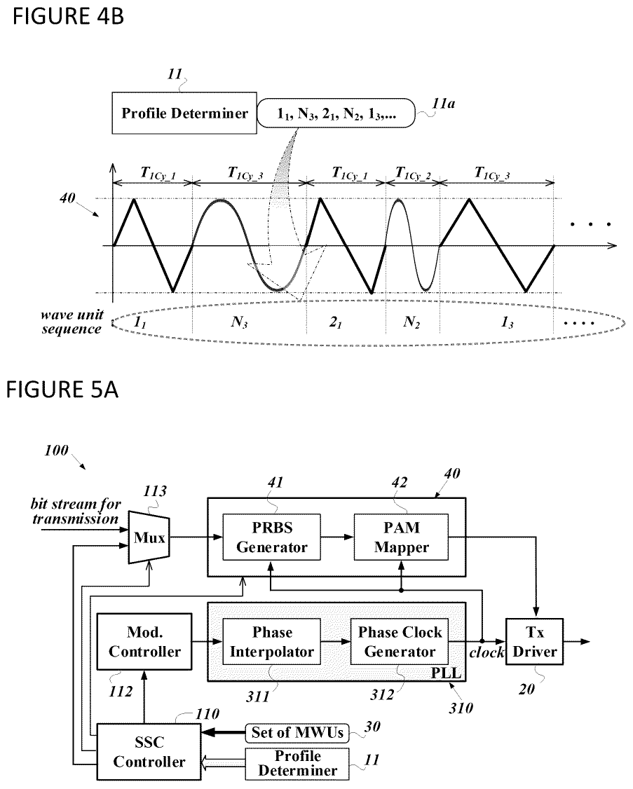

FIG. 5a is a block diagram illustrating a configuration of a data transmitter 100 according to an embodiment of the present invention. The illustrated transmitter 100 includes the profile determiner 11 and the modulation wave set 30 as described above, and these are used as described above for the setting operation for spreading the spectrum of the clock as a non-repetitive modulation profile. The modulation controller 112 and the SSC controller 110 constituting the transmitter 100 perform the setting operation of the modulation controller 12 and the SSC controller 10 for spreading the spectrum of the clock described above, and depending on the embodiments, other operations are further performed. These operations are described in detail in the corresponding part.

The illustrated transmitter 100 includes: a PLL 310 that generates a clock of a phase that matches the control signal applied from the modulation controller 112, a channel modulator 40 that modulates the input bit stream in a predetermined manner to match the channel in order to transmit the bit stream, a transmission driver 30 that captures and outputs the output signal of the channel modulator 40 in synchronization with the output clock of the PLL 310, and a MUX 113 that selects one among the plurality of inputs and applies it to the input terminal of the channel modulator 40.

And, the PLL 310 includes: a phase interpolator 311 that regulates the phase of a clock in accordance with a control signal applied thereto, and a clock generator 312 that generates a clock of a phase regulated by the phase interpolator 311. The channel modulator 40 includes: a pseudo-random encoder 41 that pseudo-randomizes the input bit stream based on an arbitrarily set pseudo-random sequence, in synchronization with the output clock of the PLL 310, and a PAM mapper 42 that amplitude-modulates the encoded bits output from the pseudo-random encoder 41 into predetermined symbol units in synchronization with the output clock of the PLL 310.

The channel modulator 40 of the transmitter 100 is illustrated together as an example to facilitate understanding of the specific description of the embodiments of the present invention, and is not configured to have a direct relationship to the spread spectrum clock to which the technical principles and ideas of the present invention are applied. Therefore, any configuration of the channel modulator configured to be able to transmit input data to the other party can be applied to the transmitter 100 illustrated for explaining the present invention.

According to an embodiment of the present invention, a receiver corresponding to the transmitter 100 may be configured as illustrated in FIG. 5b. The illustrated receiver 200 is also configured to include a modulation controller 212 and an SSC controller 210, and these controllers directly perform the modulation profile setting operation for spreading clock spectrum as described above using the profile determinator 11 and the modulation wave set 30 provided together with the receiver.

In addition to these configurations, the receiver 200 includes a PLL 320 that is configured similarly to the PLL 310 of the transmitter 100 and performs the function similar thereto. This PLL 320 differs from the PLL 310 of the transmitter 100 only in that the target of the phase regulation by the internal phase interpolator 321 is a clock that is phase-synchronized with the clock recovered from the received signal.

The receiver 200 is also configured to include: an AD converter 50 that converts a signal on a transmission channel into a digital signal in synchronization with the output clock of the PLL 320, an equalizer 60 that compensates amplitude and phase distortion of the digitally converted signal, and a clock/data recovery unit 70 that recovers clock and data from the equalized digital signal.

According to an embodiment of the present invention, when the transmitter 100 and receiver 200 configured as described above are powered on and started up, each of the SSC controllers 110 and 210 sets, in the modulation controllers 112 and 212, a modulation profile configured by referring to the modulation sequence set by the profile determinator 11 as described above.

The SSC controller 110 of the transmitter 100 activates the channel modulator 40 at the moment when the setting of the modulation profile is completed. The channel modulator 40 may be activated regardless of the setting of the modulation profile. When the channel modulator 40 is activated, the pseudo-random encoder 41 generates a pseudo-random sequence from the set code, and this sequence is modulated by the PAM mapper 42 and begins to be transmitted to the transmission channel. The pseudo-random sequence transmitted in this manner includes a special bit stream promised as a synchronization pattern in the transmission channel.

In this initial state, since it is before the modulation start signal is applied from the SSC controller 110, the modulation controller 112 does not apply a control signal (hereinafter, referred to as a ‘phase regulation signal’) for regulating the clock phase to the phase interpolator 311. That is, the phase regulation signal is maintained at 0. Therefore, the clock of the PLL 310 is maintained at the set frequency (Fₒ).

The pseudo-random sequence signal 113 transmitted by the transmission channel experiences a delay (TTD) according to the length of the transmission channel (this delay is referred to as a ‘propagation delay’) and then reaches the receiver 200. This signal is recovered to a digital signal by the AD converter 50. The synchronization detector 80 determines the correlation of a predetermined synchronization pattern signal for the recovered digital signal and searches for a synchronization pattern section accordingly. When this section is found, it notifies the section to the SSC controller 210.

Meanwhile, the SSC controller 110 of the transmitter 100 applies a modulation start signal to the modulation controller 112 at the time point (t_{S_E}) (can be determined from the activation time point for the channel modulator 114) when the transmission of the synchronization pattern is completed. As a result, the modulation controller 112 applies a phase regulation signal to the phase interpolator 311 of the PLL 310 according to the modulation waveform 401 determined by the previously set modulation profile. In accordance with the signal value of this phase regulation signal, the phase interpolator 311 regulates the variation rate of the clock phase's leading or lagging amount, and notifies the clock generator 312 of the time point corresponding to the phase determined according to the current variation rate, so that the clock is output at that time. According to this method, a clock whose frequency varies according to the modulation waveform is output from the PLL 310.

In the receiver 200, when a synchronization pattern section is notified from the synchronization detector 80, the SSC controller 210 applies a modulation start signal to the modulation controller 212 at the time point (t_{R_E}) corresponding to the completion of the section. Accordingly, the frequency modulation of the clock starts in the same manner as in the transmitter 100.

In the modulation of the clock frequency that starts from the transmitter 100 and the receiver 200, a time difference of the propagation delay time (T_{TD}) exists due to the signal delay by the transmission channel. However, since the bit stream 124 transmitted from the transmitter 100 in synchronization with the frequency-varying transmission clock also reaches the receiver 200 after the same propagation delay time (T_{TD}) in the transmission channel, the time difference is canceled out from the modulation waveform 402 of the modulation profile used to modulate the clock in the receiver.

Therefore, the amount of frequency change of the clock due to the modulation wave point (S_{PMW}) used for frequency modulation at any time point (t_{DR}) when the bit stream is received, is the same as the amount of frequency change due to the modulation waveform 401 used for frequency modulation at the time point (t_{Ds}) when transmitting the data bit stream (Δf_{Sp}). That is, in the receiver 200, a clock having exactly the same frequency (=F₀+Δf_{Sp}) as the frequency of the clock used for the bit stream in the transmitter 100 is used, so that the signal of the data bit stream is acquired from the transmission channel.

The frequency modulation for the clock in the transmitter and the receiver may not start at the time point of completion of the synchronization pattern, but may start at a time point that a specified time interval has elapsed immediately following the synchronization pattern.

In the above-mentioned embodiments, the receiver 200 is also provided with a profile determiner 11 that sets the same modulation sequence as the transmitter for spreading clock spectrum, similarly to the transmitter 100. In another embodiment according to the present invention, a receiver without a profile determinator 11 can be configured. In this embodiment, a modulation sequence for determining a modulation profile is received and used from the counterpart transmitter 100. Hereinafter, this embodiment will be described in detail on the premise that the profile determinator 11 is removed in the receiver block diagram of FIG. 5b.

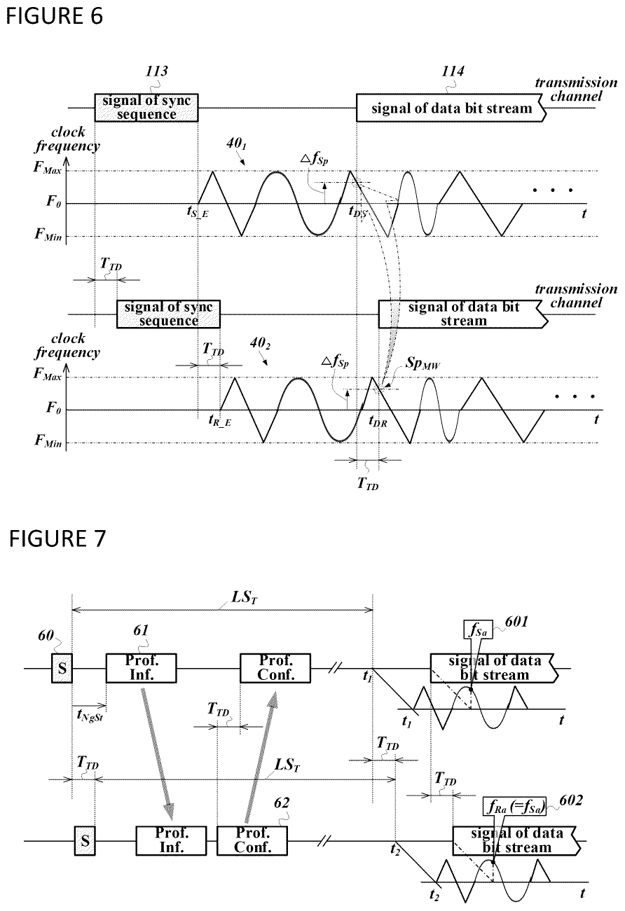

FIG. 7 schematically illustrates a process in which information about a modulation profile is transmitted to a receiver according to the present embodiment.

When power is applied, the SSC controller 110 of the transmitter 100 configures the modulation sequence confirmed from the profile determinator as the profile information 61, at a designated time point (t_{NgSt}) within the time (LS_{T}, this time is referred to as the ‘link setup time’) until before completion of the operation for channel training, from just after the synchronization pattern 60 is transmitted to the transmission channel by the activation of the channel modulator 40 as described above, and the profile information is input to the MUX 113 to transmit it to the transmission channel via the channel modulator 40. Thereby, the modulation profile sharing operation is started.

The signal of this profile information 61 carried on the transmission channel reaches the receiver 200 after the propagation delay time (T_{TD}), and is recovered to a digital signal by the AD converter 50. The distortion in the transmission channel is compensated by the equalizer 60, and is converted into a data stream by the data decision unit 90. The data stream determined by the data decision unit 90 is transmitted even to the SSC controller 210.

The SSC controller 210 of the receiver confirms the modulation sequence of the profile information from the received data stream, and sequentially reads the corresponding modulation wave units from its own modulation wave set 30 according to the confirmed modulation sequence, and sets the modulation profile in the modulation controller 212. At the same time, it configures response information 62 notifying normal reception of the profile information and transmits it to the transmission channel. Of course, the transmission of the response information is based on the premise that the transmission channel supports communication in both directions in a full-duplex or half-duplex manner.

Transmission of the response information 62 is based on the premise that the receiver 200 is provided with components for data transmission (channel modulator 40, transmission driver 20, etc.) as in the transmitter 100, and the transmitter 100 is provided with components for data reception (equalizer 60, data decision unit 90, clock/data recovery unit 70, etc.) as in the receiver 200. If the receiver 200 and the transmitter 100 are not provided with these components, the SSC controller 110 transmits the profile information to the transmission channel, and the SSC controller 210 sets the modulation profile according to the received modulation sequence to the modulation controller 212, so that the modulation profile sharing operation is completed.

If the SSC controller 110 of the transmitter 100 normally receives a response to the profile information transmission, it records that the sharing of the modulation profile is successful and completes the modulation profile sharing operation.

Even if modulation profile sharing is successfully completed, the respective SSC controllers of the transmitter 100 and the receiver 200 do not start frequency modulation of clock, and waits until the link setup time (LST) ends. When the link setup time (LS_{T}) is completed, at that time point (tᵢ, t₂), each SSC controller applies a modulation start signal to the modulation controller of the corresponding device, whereby frequency modulation of the clock starts based on the same modulation profile in each of the transmitter 100 and the receiver 200.

The link setup time (LS_{T}) is the same in the transmitter and the receiver, and the start of that time (LS_{T}) is based on the synchronization pattern 60. In the receiver 200 that receives the synchronization pattern after the propagation delay time (T_{TD}), the reference time is delayed by the propagation delay time (T_{TD}) compared to the transmitter 100. That is, the time point at which frequency modulation for the clock starts is also delayed by the propagation delay time (T_{TD}) compared to the transmitter (t₂=t₁+T_{TD}). Therefore, when the bit stream transmitted from the transmitter 100 synchronized with the transmission clock 601 of the modulation frequency at any time point reaches the receiver after the propagation delay time (T_{TD}), the reception clock 602 modulated with the same frequency as the transmission clock is used to recover the signal on the transmission channel by the bit stream into a digital signal.

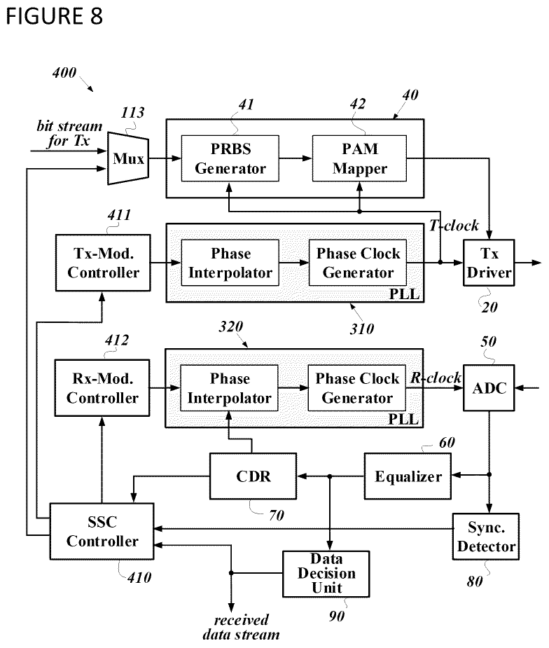

As mentioned above, data communication can be made only one-way from a transmitter to a receiver, but data communication can also be made two-way. For two-way communication, all the components for transmission and reception must be included, and in this specification, a device configured in this manner is referred to as a ‘transceiver’. FIG. 8 is a block diagram illustrating the configuration of a transceiver according to an embodiment of the present invention.

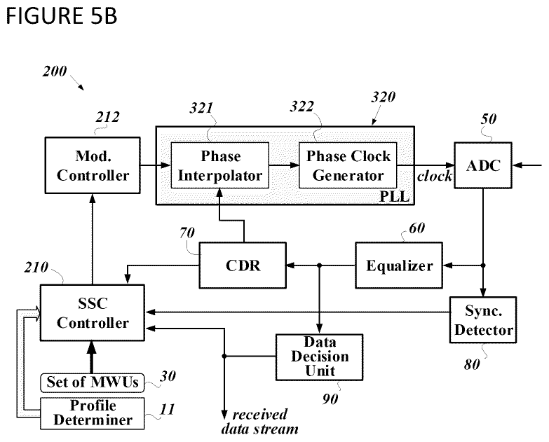

The Tx-modulation controller 411 of the transceiver 400 whose configuration is exemplified in FIG. 8 performs the same function as the modulation controller 112 of the transmitter 100 described above, the Rx-modulation controller 412 performs the same function as the modulation controller 212 of the receiver 200 described above, and the SSC controller 410 performs the integrated function of each SSC controller of the transmitter 100 and the receiver 200. That is, the start of frequency modulation of the transmission clock (T-clock) of the Tx-modulation controller 411 and the start of frequency modulation of the reception clock (R-clock) of the Rx-modulation controller 412 are controlled respectively. When both transceivers communicating with each other include a profile determiner 11, a modulation start signal is applied to each of the Tx-modulation controller 411 and the Rx-modulation controller 412 as explained with reference to FIG. 6. When only one of the two transceivers includes a profile determiner 11, a modulation profile sharing operation as explained with reference to FIG. 7 is also performed.

And, the modulation profile determined by the modulation sequence set by the profile determiner 11 or based on the shared profile information is set in common to the Tx-modulation controller 411 and the Rx-modulation controller 412, and is used together to modulate the transmission clock (T-clock) and the reception clock (R-clock).

One determined among the two transceivers performs the function of controlling the channel for data transmission. In this specification, the transceiver having this channel control function is called ‘main transceiver’, and the other transceiver that does not have this function is called ‘sub-transceiver’. If only one of the two transceivers between which a modulation profile is to be shared via communication includes a profile determiner 11, it is assumed that the profile determiner is provided in the main transceiver. This assumption is only for convenience of explanation. Considering the changes due to differences in the subjects providing and receiving profile information, the following description of the embodiments of the present invention based on the above assumption can also be applied directly to the embodiments in which the profile determination unit is provided in the sub-transceiver.

If the transmission channel through which the two transceivers 400 whose configuration is exemplified in FIG. 8 communicate with each other supports a full-duplex transmission mode, the start of modulation for the transmission clock and reception clock for each of the channels transmitted from the main transceiver to the sub-transceiver and from the sub-transceiver to the main transceiver can be performed in the same manner as described above with reference to FIG. 6 or 7, depending on whether the profile determiner of both transceivers is provided.

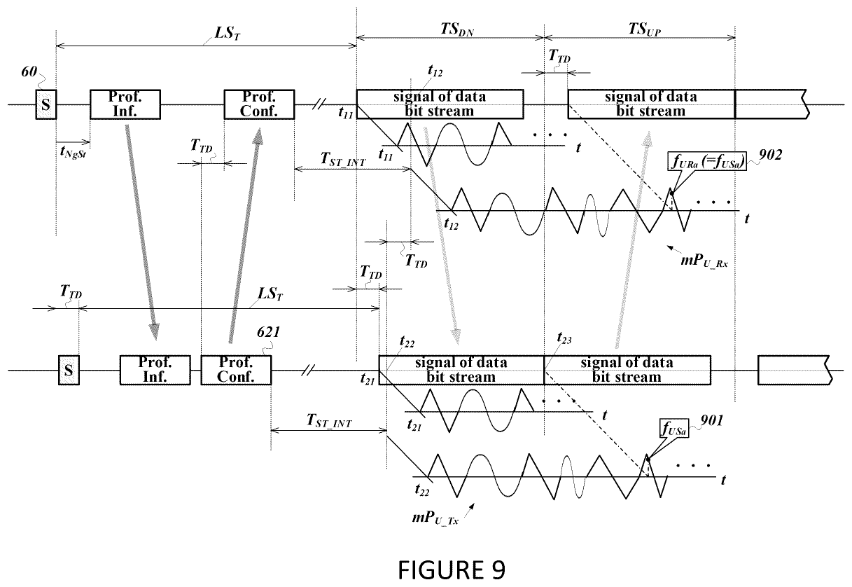

In an embodiment where the communication between the two transceivers must be performed in a half-duplex transmission manner, the modulation of the transmission and reception clocks (T-clock, R-clock) for the time slot channel (hereinafter, referred to as “down slot”) transmitted from the main transceiver to the sub-transceiver and the time slot (hereinafter, referred to as “up slot”) transmitted from the sub-transceiver to the main transceiver starts as follows. FIG. 9 schematically illustrates this.

Profile sharing between the SSC controller 410 of the main transceiver and the SSC controller 410 of the sub-transceiver, which are provided with a profile determiner, and the start of modulation according to the shared modulation profile for the transmission clock (T-clock) of the main transceiver and the reception clock (R-clock) of the sub-transceiver is performed in the same manner as described with reference to FIG. 7.

As for the transmission clock (T-clock) of the sub-transceiver, the SSC controller 410 of the sub-transceiver applies a modulation start signal to the Tx modulation controller 411 to start modulation, at the time point (t₂₂) that a designated waiting time (T_{ST_INT}) elapses from the time point when the response information 621 for the profile information received from the main transceiver is transmitted via the up channel.

As for the reception clock (R-clock) of the main transceiver, its start is determined based on the reception of the response information 621 transmitted from the sub-transceiver. When the response information 621 is received from the clock/data recovery unit 70, the SSC controller 410 of the main transceiver applies a modulation start signal to the Rx-modulation control unit 412 to start modulation, at the time point (t₁₂) that the waiting time (T_{ST_INT}) elapses from the time point when the reception is completed.

The waiting time (T_{ST_INT}) can be set to an arbitrary value in which the time point (t₂₂) when the time ends is between the time point when the above-mentioned link setup time (LST) ends and the time point when the time slot (TS_{UP}) of the up channel in the half-duplex transmission channel starts.

Further, the waiting time (T_{ST_INT}) may be also determined based on a different type of information message other than the response information 621. For example, the waiting time (T_{ST_INT}) may be designated based on a link state transition progress message transmitted to notify the main transceiver when the sub-transceiver completes link setup.

Because the start of modulation for the reception clock (R-clock) in the main transceiver is determined based on the time point according to the data received from the sub-transceiver as described above, the modulation start time point is delayed by the propagation delay time (T_{TD}) from the modulation start time for the transmission clock (T-clock) of the sub-transceiver. However, when the up slot (TS_{UP}) is made (t₂₃), the point on the modulation profile (mP_{u_Tx}) applied at that time point in order to perform a frequency modulation of the transmission clock used by the sub-transceiver for transmission of the bit stream appears after the propagation delay time (T_{TD}) in the modulation profile (mP_{u_Rx}) applied for frequency modulation of the reception clock in the main transceiver. As a result, the clock of the same frequency 902 as the clock frequency 901 used for transmission of the corresponding bit stream is used to receive the bit stream.

The above-mentioned embodiments are configured such that the transmission clock used by the sub-transceiver for transmitting the bit stream operates independently of the reception clock.

Without being limited to these embodiments, the method for spreading clock spectrum according to the present invention can also be applied to a sub-transceiver that uses the reception clock recovered from the received bit stream as a transmission clock. The method of using the reception clock as a transmission clock is called ‘loop timing’, and the following describes a case where the method for spreading clock spectrum is applied to a pair of transceivers to which this loop timing is applied.

According to an embodiment of the present invention, the configuration of the main transceiver to which loop timing is applied is the same as the configuration of the transceiver 400 illustrated in FIG. 8. However, some functions of the SSC controller 410, more specifically, the determination of the timing for applying the modulation start signal to the Rx-modulation controller 412, are different. This will be described hereinafter.

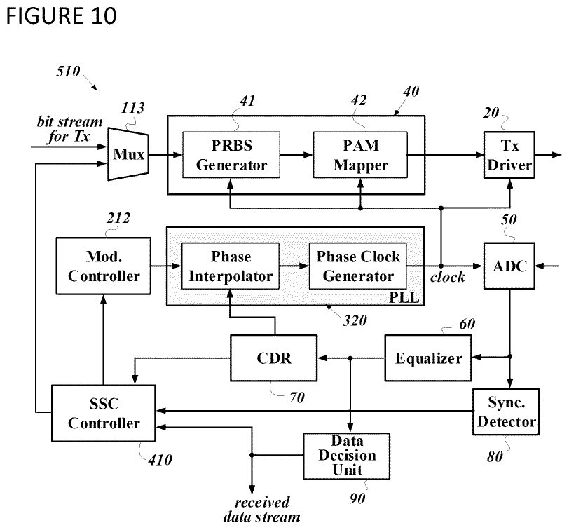

According to an embodiment of the present invention, a sub-transceiver to which loop timing is applied may be configured as illustrated in FIG. 10. The sub-transceiver 510 of the present embodiment is not provided with a PLL for a transmission clock, and is configured to use the reception clock recovered from the clock/data recovery unit 70, more specifically, its own clock that is phase-synchronized with the reception clock, for data transmission as it is. That is, it is configured so that the recovered reception clock is also applied to the channel modulator 40 and the transmission driver 20.

The method of determining the time point at which the SSC controller 410 of the sub-transceiver 510 sets the modulation profile to the modulation controller 212 and applies the modulation start signal for the clock to the modulation controller 212 is the same as described above. That is, the modulation start signal is applied to the modulation controller 212 at a specific time point determined based on the time point at which the synchronization pattern is detected from the transmission channel.

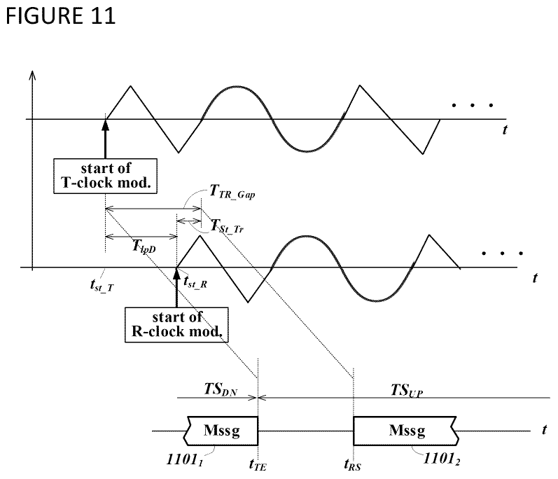

The SSC controller 410 of the main transceiver 400 whose configuration is exemplified in FIG. 8 determines the modulation start time for the reception clock (R-clock) based on the start time point (t_{st_T}) of the frequency modulation for the transmission clock (T-clock), as exemplified in FIG. 11. The determination of the start time point (t_{st_T}) of the frequency modulation for the transmission clock (T-clock) is performed in the same manner as in the above-described embodiments.

As for the reception clock (R-clock), the SSC controller 410 applies a modulation start signal to the Rx-modulation controller 412 at a time point (t_{st_R}) that the loop time (TIP) elapses from the time point when the modulation start signal is applied to the Tx-modulation controller 411. The loop time (T_{IPD}) is determined by two time elements, as illustrated in the figure, wherein one is the gap time between signals (T_{TR_Gap}), and the other is the state transition time (T_{st_Tr}) of the sub-transmitter 510, more specifically, the transition time from reception to transmission.

As for the gap time between signals (T_{TR_Gap}), as illustrated in FIG. 11, the SSC controller 410 measures the time from the time point (t_{TE}) when the transmission of an arbitrary message 11011 transmitted to the sub-transceiver 510 during the link setup time is completed to the time point (t_{Rs}) when the message 11012, more specifically, the frame that transmits the message, starts to be received. If a half-duplex bidirectional communication is applied between the main transceiver and the sub-transceiver, the time from the end of the down slot transmitting an arbitrary message to the time when the message is received on the up channel can be the gap time between signals (T_{TR_Gap}).

And, the value set in the main transceiver 400 is used as the state transition time (T_{st_Tr}). This value may be recorded as data in the SSC controller 410 of the device, or may be a value set in a component such as a DIP switch. Alternatively, a value indicating the state transition time (T_{st_Tr}) may be set in the sub-transceiver 510, and transmitted to the SSC controller 410 of the main transceiver 400 by an information message that is mutually communicated during the link setup time.

The state transition time (Tₛₜₘ) corresponds to the processing time from immediately after the sub-transmitter 510 detects the end of the down slot on the transmission channel to when it starts transmitting its own data stream to the transmission channel. Therefore, the time required for data to purely go back and forth on the transmission channel, i.e., the loop time (T_{1pD}), is the time obtained by subtracting the state transition time (T_{st_Tr}) from the signal gap time (T_{TR_Gap}). The transmission clock (T-clock) of the main transceiver 400 is relatively delayed by the transmission clock (T-clock) by the time (T_{1pD}) that the clock that is recovered and returned to the sub-transmitter 510 by the loop timing.

Therefore, when the SSC controller 410 calculates the loop time (T_{1pD}) as described above before starting the frequency modulation for the transmission clock (T-clock), and then applies a modulation start signal to the Tx-modulation controller 411, it applies a modulation start signal to the Rx modulation controller 412 when the calculated loop time (T_{1pD}) has elapsed (t_{st_E}) from that point (t_{st_T}).

By starting the frequency modulation of the reception clock (R clock) in this manner, even the main transceiver 400 to which loop timing is applied can receive the bit stream as a clock whose frequency is exactly synchronized with the clock synchronized at the time of transmission.

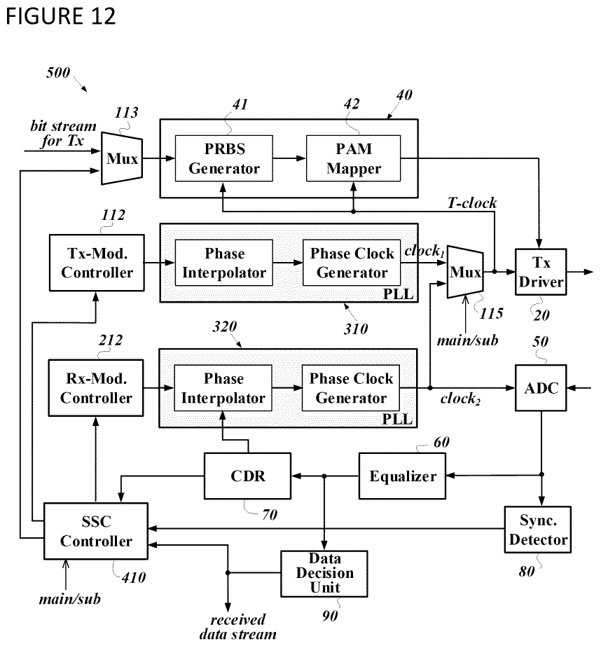

In the above description of the method for spreading clock spectrum by applying the loop timing, the main transceiver 400 and the sub transceiver 510 are configured differently from each other, but for the efficiency of manufacturing communication devices, both transceivers can be configured in the same way. FIG. 12 is a block diagram of a transceiver 500 configured according to this embodiment.

The transceiver 500 of FIG. 12 can be used as both a main transceiver and a sub-transceiver to which loop timing is applied, and further comprises a MUX 115 that selects one of the two input clocks (clock₁, clock₂) and outputs it as a transmission clock (T-clock) so that it can be selectively applied to the transmission clock (T-clock) applied to the channel modulator 40 and the transmission driver 20. In this MUX 115, the first clock (clock1) of the PLL 310 that phase-modulates an oscillation clock recovered from the received data stream and phase-synchronized with the clock according to a modulation profile and outputs the phase-modulated oscillation clock, are input, respectively.

Further, a selection signal for selecting an input terminal is applied to the MUX 115, and this selection signal uses an operating mode value that sets whether the transceiver operates as a main transceiver or as a sub-transceiver, wherein this operation mode value can be specified by a component such as a jumper configured in the circuit of the transceiver 500 that can selectively set a specific value to the transceiver. If this operation mode value specifies the ‘main mode’, the MUX 115 is configured to output the first clock (clock₁), and if it specifies the ‘sub-mode’, the transceiver 500 is configured to output the second clock (clock₂).

Further, the transceiver 500 is also configured with circuits so that the operation mode value set by components, etc. is also applied to the SSC controller 410. Therefore, if the applied operation mode value corresponds to the ‘main mode’, the SSC control unit 410 performs an operation of applying a modulation start signal to the Rx-modulation controller 412 based on the loop time calculation and the calculated loop time, as explained with reference to FIG. 11, and if it is the ‘sub mode’, it is configured not to perform this operation.

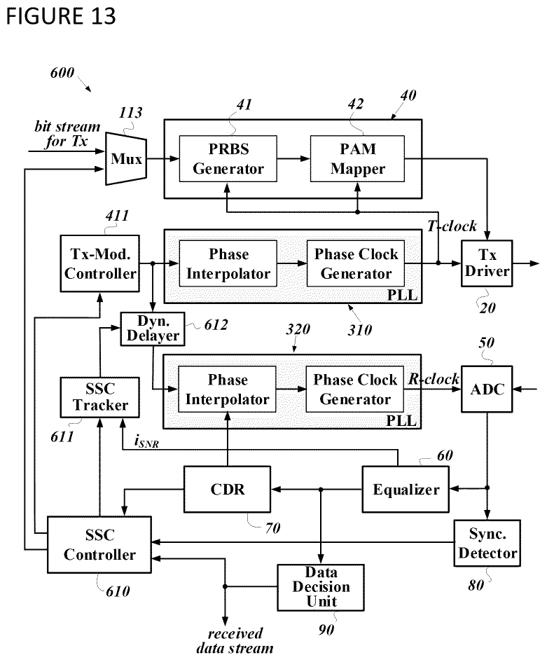

Meanwhile, in the above-described embodiments, in the main transceiver to which the loop timing is applied, the loop time (T_{1PD}) is determined from the preset state transition time (T_{st_Tr}), and this is used to determine the timing of application of the modulation start signal for the reception clock (R-clock). However, in another embodiment of the present invention, even if the state transition time (T_{St_Tr}) is not known in advance, the frequency modulation of the clock can be performed in accordance with the delay time of the clock returned from the sub transceiver by the loop timing. FIG. 13 is an example of a block diagram of a main transceiver 600 configured for the present embodiment.

The main transceiver 600 is configured to further include: a modulation delay unit 612 configured to dynamically delay and output a phase regulation signal for frequency modulation output from a Tx-modulation controller 411 in accordance with a delay control signal applied thereto, and an SCC tracker 611 configured to regulate the delay control signal according to a signal-to-noise ratio of a received data stream, wherein the SSC controller 610 further has a function of controlling the SSC tracker 611.

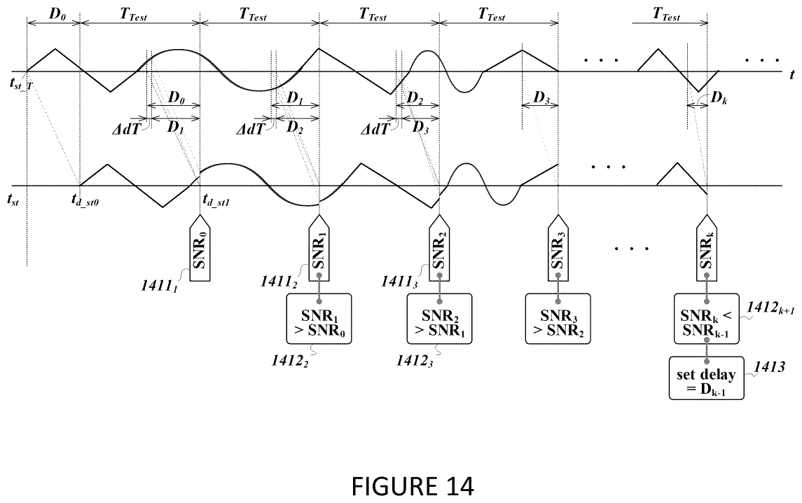

FIG. 14 is an example of timing for frequency modulation of the reception clock (R-clock) in the main transceiver 600 according to an embodiment of the present invention, and shows finding and applying the frequency modulation timing that matches the reception clock (R-clock) returned by loop timing. This modulation timing search process may be performed during the link setup time described above.

The SSC controller 610 first grasps the gap time between signals (T_{TR_Gap}) as described above. Then, when the gap time between signals (T_{TR_Gap}) is confirmed, a modulation start signal is simultaneously applied to the Tx-modulation controller 411 and the SSC tracker 611 (tₛₜ). When the modulation start signal is applied to the SSC tracker 611, information on the obtained gap time between signals (T_{TR_Gap}) is transmitted.

When the modulation start signal is applied, the SSC tracker 611 sets the gap time between signals (T_{TR_Gap}) transmitted during application as the initial delay time (Do) to the modulation delay unit 612 and starts the dynamic delay operation. Accordingly, the phase regulation signal for frequency modulation of the transmission clock (T-clock) output by the Tx-modulation controller 411 is delayed by the initial delay time (D₀) by the modulation delay unit 612 and then starts to be applied to the PLL 320 that synchronizes the phase of the reception clock (R-clock) (t_{d_st0}).

Further, the SSC tracker 611 confirms the signal-to-noise ratio of the data stream received from the opposite-side transceiver using the equalizer 60 during the preset test cycle (Tₜₑₛₜ) from the time point that the initial delay time (D₀) elapses, and records the average value (SNR₀) for the corresponding cycle (Tₜₑₛₜ) (1411₁). At the same time, it applies a delay control signal that sets the delay time of the modulation delay unit 612 to a delay time (Dᵢ) that is reduced by the preset resolution gap (ΔdT). Accordingly, the phase control signal output by the Tx-modulation controller 411 is delayed shorter by the resolution gap (ΔdT) and begins to be applied to the PLL 320 (t_{d_st1}).

After regulating the delay time of the modulation delay unit 612, the SSC tracker 611 confirms (i_{DNR}) the signal-to-noise ratio of the received data stream from the equalizer 60 during the next test cycle (Tₜₑₛₜ), and records the average value (SNR₁) in that cycle 1411₂. Then, if there is an average value of the previously recorded signal-to-noise ratio, the average value (SNRₒ) is compared with the just-obtained average value (SNR₁). In this comparison, if it is confirmed (1412₂) that the presently obtained average value (SNR₁) of the signal-to-noise ratio is higher than the previous average value (SNR₀), the SSC tracker 611 further performs the aforementioned test method during the next test cycle.

During the above-described operation for each test cycle (Tₜₑₛₜ), if it is confirmed that the presently obtained signal-to-noise ratio average (SNRₖ) is lower than the previously obtained signal-to-noise ratio average (1412ₖ₊₁), the SSC tracker 611 resets the delay time (Dₖ₋₁) to be longer than the current delay time (Dₖ) set to the modulation delay unit 612 by the resolution gap (ΔdT) (141₃). Thereby, the modulation profile applied to the clock used for synchronizing the transmitted data stream is applied to the frequency modulation of the reception clock with a timing that exactly matches the delayed clock that returns according to the loop timing.

In an embodiment of the present invention, the search for the above-described modulation delay time may be performed repeatedly several times, and the modulation delay time having the highest frequency among them may be finally applied to the modulation delay unit 612, to complete the modulation timing search process.

In the above-described embodiment, the signal gap time (T_{TR_Gap}) is set in an initial stage as the delay time in the modulation delay unit 612, and then the delay time is reduced by the resolution gap (ΔdT) to find the modulation delay time, but the modulation delay time can also be found in the opposite manner. That is, after setting an arbitrarily set initial delay time (this time may be zero) to the modulation delay unit 612, the delay time of the modulation delay unit 612 is increased by the specified resolution gap (ΔdT) for each test cycle (Tₜₑₛₜ), and the modulation delay time can be found.

Meanwhile, when a pair of transceivers are configured to apply loop timing, even if the transceiver that generates the transmission clock by itself performs frequency modulation using a repeated modulation wave unit for the transmission clock, the above-mentioned modulation timing search process can naturally be applied to find and set the modulation timing for the reception clock.

The method for spreading the spectrum of the data transmission clock according to the present invention, various embodiments of the device for the method, and the configuration and operation described in the embodiments, as specifically described so far, can be selectively combined and realized in various ways, unless they are not compatible with each other.

The above-mentioned embodiments of the present invention have been disclosed for illustrative purposes, and those skilled in the art will appreciate that various improvements, modifications, substitutions or additions can be made in the embodiments without departing from the technical spirit and scope of the present invention disclosed in the appended claims.

### DESCRIPTION OF REFERENCE NUMERALS

10, 110, 210, 410, 610: SSC controller
11: profile determiner
11a: modulation sequence
12, 112, 212, 312: modulation controller
20: transmission driver
40: channel modulator
41: pseudo-random encoder
42: PAM mapper
50: AD converter
60: equalizer
70: clock/data recovery unit
80: synchronization detector
90: data decision unit
100: transmitter
113: MUX
200: receiver
310, 320: PLL
311, 321: phase interpolator
312, 322: clock generator
400: transceiver
411: Tx-modulation controller
412: Rx-modulation controller
500: transceiver
510: sub-transceiver
600: main transceiver
611: SSC tracker
612: modulation delay unit

What is claimed is:

1. A device that performs data communication with a counterpart device via a transmission channel, the device comprising:
a PLL configured to modulate and output a frequency of a clock used to synchronize communication data in accordance with a regulation signal applied thereto,
a first controller configured to generate the regulation signal according to a modulation waveform which is a successive form of a plurality of modulation wave units determined by a set modulation profile, and apply the regulation signal to the PLL,
a main controller configured to control the first controller so that application of the regulation signal to the PLL is started,
wherein the modulation wave unit is a signal whose sum of signal values during its time length becomes zero for the first time, and
wherein at least two successive modulation wave units among the plurality of modulation wave units differ from each other in at least one of the time length and the form of the signal.

2. The device of claim 1, wherein:
the main controller is configured such that modulation wave units each corresponding to a series of modulation wave unit identifiers set a waveform having a successive form in the order of their identifiers as the modulation profile in the first controller.

3. The device of claim 2, wherein:
the main controller is configured to confirm the series of modulation wave unit identifiers from data encoded by a component provided in the device.

4. The device of claim 2, wherein:
the main controller is configured to receive information about the series of modulation wave unit identifiers from the counterpart device.

5. The device of claim 1, wherein:
the clock is a clock used to capture and receive a signal carried on the transmission channel as a digital signal.

6. The device of claim 5, wherein:
the main controller is configured to control the first controller so that application of the regulation signal to the PLL is started at a time point that a predetermined time elapses from the time point when a specific pattern is detected on the transmission channel.

7. The device of claim 5, wherein:
the main controller is configured to control the first controller so that application of the regulation signal to the PLL is started at a time point that a predetermined time elapses from the time point when a message of a specific information is received from the counterpart device.

8. The device of claim 7, wherein:
the specific information is information notifying that information about the plurality of modulation wave units has been successfully received.

9. The device of claim 5, wherein:
the device is configured such that the clock can also be used to transmit a data stream to the transmission channel, the data stream being for transmitting to the counterpart device.

10. The device of claim 9, further comprising:
a second PLL configured to modulate and output the frequency of a second clock used to synchronize a data stream transmitted to the counterpart device in accordance with a regulation signal applied thereto, and
a MUX that selects one of the clock and the second clock according to a designated mode and outputs it to be used to synchronize a data stream transmitted to the transmission channel,
wherein the mode is designated by a component that is circuit-configured in the device and capable of selectively setting a specific value.

11. The device of claim 1, wherein:
the clock is a clock used to transmit a data stream to the transmission channel, the data stream being for transmitting to the counterpart device.

12. The device of claim 11, further comprising:
a second PLL configured to modulate and output a frequency of a second clock recovered from the digital signal, which is used to capture and receive a digital signal from a signal carried on the transmission channel, in accordance with a second regulation signal applied thereto, and
a second controller configured to generate the second regulation signal according to the modulation waveform and apply it to the second PLL,
wherein the main controller is further configured to control the second controller so that application of the second regulation signal to the second PLL is started, when the loop time has elapsed from the time point when the first controller is controlled to start application of the regulation signal to the PLL, and
wherein the main controller is configured to determine the loop time based on a time gap from immediately after transmitting a message to the counterpart device to the time point when the message starts to receive from the counterpart device.

13. The device of claim 12, wherein:
the main controller is configured to determine, as the loop time, a time obtained by subtracting the previously confirmed reception/transmission switching time of the counterpart device from the time gap.

14. The device of claim 11, further comprising:
a second PLL configured to modulate and output a frequency of a second clock recovered from the digital signal, which is used to capture and receive a digital signal from a signal carried on the transmission channel, in accordance with a second regulation signal applied thereto,
a delay unit configured to delay the regulation signal by a delay time according to a delay control signal applied thereto and output it as the second regulation signal, and
a tracker configured to regulate a delay time of the regulation signal in the delay unit according to a signal-to-noise ratio of a data stream recovered from the digital signal, and apply the delay control signal corresponding to the regulated delay time to the delay unit.

15. The device of claim 14, wherein:
the tracker is configured to confirm the signal-to-noise ratio of the recovered data stream for each designated interval, and when the presently confirmed second signal-to-noise ratio is lower than the previously confirmed first signal-to-noise ratio, re-apply the delay control signal that was applied to the delay unit when the first signal-to-noise ratio was obtained, and complete regulation of the delay time of the delay unit.

16. The device of claim 14, wherein:
the tracker is configured to apply a time gap from immediately after transmitting a message to the counterpart device to the time point when the message starts to receive from the counterpart device as an initial delay time to the delay unit, and then regulate the delay time to a delay time shorter than the previous delay time each time the delay time is regulated.

17. The device of claim 14, wherein:
the tracker is configured to apply a predetermined time as an initial delay time to the delay unit, and then regulate the delay time to a longer delay time than the previous delay time each time the delay time is regulated.

18. The device of claim 11, wherein:
the main controller is configured to apply the control signal to the first controller, which causes application of the regulation signal to the PLL to start at a time point that a predetermined time elapses from the time point when a signal of a specific pattern is transmitted through the transmission channel.

19. A device that performs data communication with a counterpart device via a transmission channel, the device comprising:
a PLL configured to modulate and output a frequency of a clock used to synchronize communication data in accordance with a regulation signal applied thereto,
a second PLL configured to modulate and output a frequency of a second clock recovered from the digital signal, which is used to capture and receive a digital signal from a signal carried on the transmission channel, in accordance with a second regulation signal applied thereto,
a first controller configured to generate a first regulation signal according to a modulation waveform which is a successive form of a plurality of modulation wave units determined by a set modulation profile, and apply the first regulation signal to the first PLL,
a delay unit configured to delay the first regulation signal by a delay time according to a delay control signal applied thereto and output it as the second regulation signal,
a tracker configured to regulate a delay time of the first regulation signal in the delay unit according to a signal-to-noise ratio of a data stream recovered from the digital signal, and apply the delay control signal corresponding to the regulated delay time to the delay unit, and
a main controller configured to control the first controller so that application of the first regulation signal to the first PLL is started, and configured to include wherein the modulation wave unit is a signal whose sum of signal values during its time length becomes zero for the first time, and configured to include a main controller configured to control the tracker to start regulation of the delay time for the first regulation signal.

20. A method for communicating data with a counterpart device via a transmission channel, the method comprising:
confirming the set modulated wave data,
setting a modulation waveform as the modulation profile, the modulation waveform being a form in which a plurality of modulation wave units indicated by the confirmed modulation wave data are successively formed, and
generating a regulation signal according to the modulation waveform and apply the regulation signal to a PLL configured to modulate and output the frequency of a clock used to synchronize communication data,
wherein the PLL is configured to modulate the frequency of the clock according to the regulation signal,
wherein the modulation wave unit is a signal whose sum of signal values over the time length becomes zero for the first time, and
wherein at least two successive modulation wave units among the plurality of modulation wave units differ from each other in at least one of the time length and the form of the signal.
